(19) United States
(12) Patent Application Publication
(10) Pub. No.: US 2016/0198637 A1
(43) Pub. Date: Jul. 14, 2016

(54) METHODS AND SYSTEMS FOR HIGH VOLTAGE TREATMENT OF SOIL AND PLANT

(71) Applicant: Ali Mirzakhani Nafchi, Lake Alfred, FL (US)

(72) Inventor: Ali Mirzakhani Nafchi, Lake Alfred, FL (US)

(21) Appl. No.: 14/876,834

(22) Filed: Oct. 7, 2015

(30) Foreign Application Priority Data
Oct. 8, 2014 (US) 62061371

(51) Int. Cl. A01G 7/04

(52) U.S. Cl. CPC A01G 7/04

(57) ABSTRACT

This device functions by inducing a high voltage, low amperage current through an infected plant, tree or/soil. The high voltage low amperage treatment, can configure as treatment of the voltage about 12V to 120 KV with amperage around 0.1 mA to 57 mA. The method of high voltage treatment for plant, tree and soil is to control or reduce the impact of infestation of pest/s or diseases in plant, tree or soil. The treatment can be used in combination with other treatments to reduce the usage of chemicals. The treatment can increase the growth, break the dormancy and cause advance blooming. After receiving the voltage treatment, the plant allows electrons to flow to discharge points on the plant and reopening the clogged vascular system. Subsequently combat with the weaker and garbled bonds is much easier and the other treatments become more effective.

### STATEMENT OF NOT FUNDED OR GRANTED BY FEDERAL FUND

Hereby, it is declare that, the present disclosure has not supported with federal money or grant. It is also, stated that the invention rights has waived to inventor by University of Florida.

### BACKGROUND

Pest infestation to trees and also plants can cause severe economic loss to farmers and can adversely impact produce prices. Moreover there are no cures for some diseases so far. For example, Huanglongbing (HLB) infects citrus trees and have resulted economic loss to farmers due to crop acreage reduction, yields, and fruit quality.

The most effective nematicide (Temik G15) is no longer available. Also, in agricultural production there is a willing for pest management with environmental friendly techniques. High voltage electricity could be an alternative method for pest management in crop production which, the method is environmental friendly and inexpensive.

Several investigation have shown yield increases from plants which were subjected to an electrical treatment, although, there is no background related to use of high voltage for pest management.

Borer insects may feed in the burrow beneath the bark, or deep in the heartwood. The trees infested by borer insects in severe infestations can result in the decline and death for infected trees.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram illustrating an exemplary voltage plant treatment system according to various embodiments of the present disclosure.

FIG. 2 is a block diagram illustrating another exemplary voltage soil treatment system according to various embodiments of the present disclosure.

FIGS. 3 is image of an exemplary discharge bars of the high voltage plant and root treatment system of FIG. 1 according to various embodiments of the present disclosure:

FIG. 4 is an image of a user employing the voltage plant treatment system of FIG. 1 according to various embodiments of the present disclosure.

FIG. 5 is hypotheses graphically illustrating an example of the movement of ion charges in a plant treated by the voltage plant treatment system of FIG. 3 according to various embodiments in the present disclosure.

FIGS. 6A-6H are graphical representations illustrating examples of interactions between electrons, biofilms, and pathogens in a plant treated by the voltage plant treatment system of FIG. 1 according to various embodiments of the present disclosure.

FIGS. 7A and 7B are images illustrating examples of infected seedlings before and after treatment using the voltage plant treatment system of FIG. 1 according to various embodiments of the present disclosure.

FIGS. 8A, 8B, 9A, and 9B are images illustrating examples of infected trees before and after treatment using the voltage plant treatment system of FIG. 1 according to various embodiments of the present disclosure.

FIGS. 10A-10J are images illustrating examples of new shoots grown on an infected plant after treatment using the voltage plant treatment system of FIG. 1 according to various embodiments of the present disclosure.

### DETAILED DESCRIPTION

The present disclosure describes various embodiments for systems, devices, and methods for pest control and the methods to reduce the infection/s or impact of the infection/s in plants. In one embodiment, among others, a method for reducing the impact of infections in plant, tree or/and soil particles comprises inducing a high voltage, low amperage preferably DC current through and via the infected plant, tree or soil particles.

The plant, tree or/and soil particles under the high voltage treatment, become part of the high voltage discharge circuit/s during the treatment: For example, in a high voltage discharge circuit, a positive terminal of an electricity current can be connected to a distributor unit and high voltage generator, while a negative terminal of the voltage source can be connected to at least a ground terminal or connected proximate to the roots system of an infected plant or tree.

Alternatively, the negative terminal of the voltage source can be connected to the distributor unit and high voltage generator, while the positive terminal of the voltage source can be connected to the ground terminal or connected proximate to the roots of the infected plant. Also, possibly by at least a mechanical or an electronic relay switch/s the positive and the negative of the discharge circuit/s can switch to each other to reverse the electrons flow direction.

In soil treatment the soil zone under treatment is invaded by storm of electrons to control nematodes, while possibly the soil zone under treatment can also be under influence of magnetic or electro-magnetic field. This magnetic field's characteristics can be vary under different condition and by controlling system some of the parameter like magnitude, flux density, direction, duration and timing consider to be optimized.

There is at least one discharge circuit/s limited up to infinity circuit/s which, electrons can flow through and discharge the high voltage electricity to the relevant or corresponding discharge point/s to the other side of discharge circuit/s. In the high voltage discharge circuit, the plant, tree or soil particles under treatment, are part of the high voltage discharge circuit/s. These discharge circuit/s constantly change during treatment.

In one embodiments the distribution unit can comprise a distributor and an ignition coil, which also, can use other type of high voltage pulse/s generator to be configured to generate high pulse/s voltages. The distribution unit can be connected to discharge point/s along a discharge bar/s via distribution wires. In one of the embodiments where the positive terminal of the voltage source is connected to the distribution unit, positive discharge points can be located on/along the discharge bar/s.

Discharge bar/s move inside/side of the canopy to stablish the discharge circuit/s throughout the plant, tree or/and soil particles under treatment. In such embodiments, negative discharge points will be located at bottom side proximate to the roots zone of the plant, tree or/and soil particles under treatment, to provide negative discharge point/s.

The distributer/s and controller/s unit can control the frequency, rhythm, direction, duration, voltage-amperage magnitude of generated pulse/s. To increase the number of discharge circuit/s the number of ground terminal can increase to more than one ground terminal to several number/s of ground discharge point/s 117. In one of the embodiments, there are several number of ground discharge point/s also, there is a distributer to switch the circuit/s from one ground discharge point, to another.

In such embodiments, by switching the negative discharge points through a distributor and also by shifting the discharge points, the number of discharge circuit/s can increase up, limited to infinity discharge circuits throughout the plant, tree or/and soil zone under treatment. In one of the embodiments with numbers of positive and negative discharge points, the positive and negative discharge points can shift to each other in a way to change off the direction of electrons flow.

In the other hand, the series of positive discharge points can switch or inverse to be negative discharge points while at the same time the negative discharge point/s shift or convert to be positive discharge points. The switching frequency of positive discharge points to the negative discharge point/s and vice versa, can control by a device like a relay/s or multiplexer/s switch or other controller.

The high pulse/s voltage is generated by a suitable high voltage generator which can be as simple as a coil set up or any kind of safe electronic circuit/s design to provide high voltage as per requirement/s for the treatment. Meanwhile, the high generated voltage pulses with low amperage can be provided to the discharge points on a discharge bar. A spark of high voltage current can then discharge from the positive discharge points to correspondent negative discharge points on the plant, tree or/and the soil particles in the zone under treatment.

In this way, the storm of electrons can be induced to the subject via discharge circuit/s comprising plant, tree or/and soil particles as a part of circuit/s. In one of the embodiments for soil treatment against nematodes or some other pest, two or more of discharge points is placed on or in the top-soil. In case of on-the-go mentioned high voltage treatment the mentioned discharge point/s place on a wheel or disc to connect to the soil during the treatment while the device moving forward.

The discharge points can be placed on two bar/s with different charges that alternately and frequently switch and inverse the terminal charges from positive to negative and vice versa. The mentioned two discharge bar/s with opposite charge can be positioned in/on or out of the zone of soil under treatment. In pest control by high voltage treatment, for the optimization of the treatment performance, any positioning angle or changing the components of the discharge bar/s will be considered for future design.

The soil zone under treatment will be invaded by storm of electrons trough soil particles which this invasion can be occurs simultaneously while the soil particles are under influence of electromagnetic field. The possibly electromagnetic field also has a frequency from zero to more than zero as per the requirements. The number of discharge points on the discharge bar/s can be more than one discharge point.

In one embodiment among the embodiments at least one or more switch, relay, multiplexer or/and controller can distribute the high voltage pulses from one discharge point to another. The switching or shifting the current of high voltage electricity from one discharge point to another can occurs with different frequency and rhythm, which results changing of the discharge circuit/s.

Subsequently, by changing the discharge circuit/s, therefore, more soil particles, or tree and plant cells can become as a part of a discharge circuit/s. By frequently switching the discharge points and also changing the position of the device or apparatus during the treatment, the number of circuits can increase up to infinite discharge circuits.

In one of embodiments where the negative discharge point/s are connected to the canopy discharge bar/s, negative discharge points can make a circuit from such negative discharge point/s throughout plant, tree as a part of discharge circuit, In such embodiments, positive discharge points will be located throughout the lower discharge bar/s or ground discharge bar/s, discharge the storm of electrons into discharge circuit/s which are plant, tree or/and soil particles under the treatment.

After receiving the high voltage treatment, the plant or tree can be stimulated to regenerate and grow new leaves, shoots, and/or flashes. High voltage treatment as electro invasion to the soil particles also, may or may not be simultaneously under influence of electromagnetic field which, destruct the pest/s and nematodes in the region under treatment. Furthermore, the high voltage treatment as electro-invasion to a tree canopy, trunk or branches which, may or may not be simultaneously under influence of electromagnetic field which, can destruct and control infestations of borer insects in the heartwood of trees or plants.

In the same way, the high voltage treatment as electro-invasion to the plant or tree canopy including the root system which may or may not be simultaneously under influence of electromagnetic field, controls the destructive impact of some diseases infection. Some of diseases cause vascular clogging in plants or trees vascular system.

The plant diseases cause vascular clogging, not only feeding from nutrition but also, and starving the infected plant or tree by preventing of food and nutrition distribution. The vascular clogging may happen because of creating strong pathogen-biofilm bond/s in the phloem-xylem system. The high voltage treatment for the plant or tree can cause shaking the vascular clogging.

The high voltage treatment can reduces effect of diseases infections in vascular clogging diseases and this treatment can be used either, with, before or after other supplementary treatment for pest control in plants and trees. However, the treatment can be used for improving the plant/s or tree health, and also, to brake dormancy or increase yield.

For example, in some diseases like Huanglongbing the disease spreads to the phloem vascular system where it starves the tree of nutrients, slowly killing the tree. In the first step of using the high voltage treatment to combat Huanglongbing diseases, the high voltage electricity treatment can break down the pathogen-biofilm bonds, which cause clogged sieves in phloem vascular system. HLB infected plants can be recognized by yellowish veins on leaves of the infected plants. HLB bacteria can cause extensive necrosis and clogging of sieves in phloem of plant.

Since, the available industrial treatments like chemicals or steams cannot terminate the disease infection nor reach to the plant or tree's roots, and also, the other treatments cannot terminate some of infestations of diseases, the treatment of high voltage treatment can be used as a method to prepare the plant and tree for an effective treatment.

The high voltage treatment, can be used as a combination with other treatments which means the high voltage electricity treatment can induce a current from the roots to the top of the tree or plant to treat plant vascular clogging diseases like citrus greening disease. The treatment has the potential to reduce the effect of other diseases that cause vascular clogging in plants. At the same time, the high voltage treatment for diseases through the roots system, the applied electro-invasion can control the root's nematodes as well.

As a tree or plant invaded by high voltage electricity, storm of electrons flow across entirely to the region of the body under the treatment. The electrons flow through number/numbers of discharge circuits limited to infinity, to shake, break, or interrupt the clogged vascular xylem or phloem by the pathogen-biofilm bonds. The shaking and disturbing those bonds results material movement and stirabout in vascular system, subsequently combat with the weaker and garbled bonds is much easier and the other treatments become more effective.

For example, by inducing a pulsed current through an infected plant or tree the high voltage pulses can break and disrupt ion bonds or weakening them in a pathogen-biofilm bond/s of Huanglongbing in a phloem of the infected tree. In some cases, inducing a high voltage pulsed current through a plant or tree can release hormones which can stimulate growth and generates new leaves, shoots, and/or flashes on the treated plant or tree. The pulsed current induced through the infected plant and/or the released hormones can inhibit and/or destroy bacteria and/or harmful pathogens in or on the infected plants.

At least one discharge bar with number/s of discharge point/s moves inside/side of the tree canopy and discharge the high voltage electricity. The canopy entirely or partially, can be covered by an electromagnetic field at the time of treatment. Although the magnetic field can establish partially and individually on discharge bar/s.

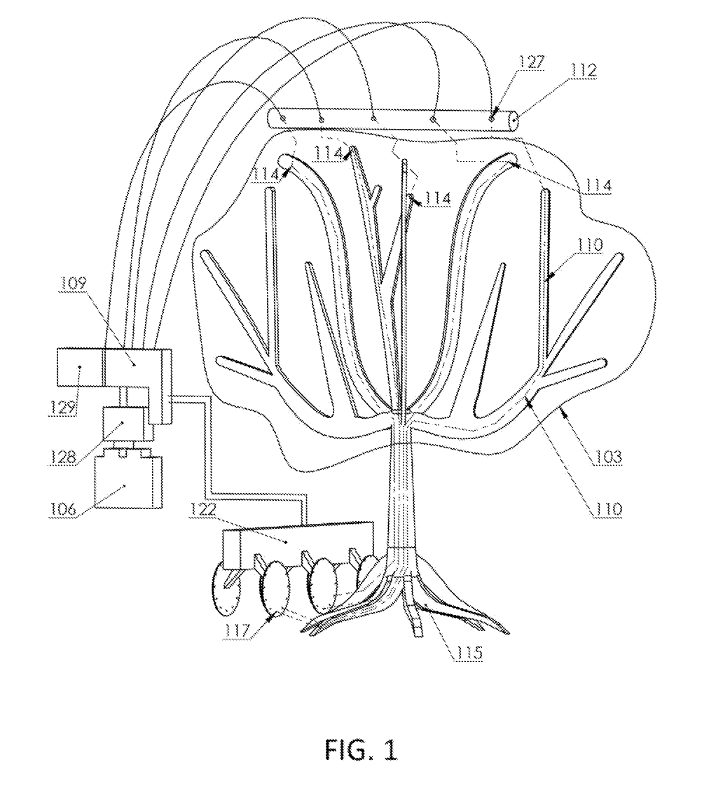

Referring to FIG. 1, shown is a block diagram illustrating an example of a voltage plant treatment system for treatment of a plant 103 according to various embodiments of the present disclosure. The plant treatment system can comprise a DC voltage source 106, a distribution unit 109, discharge circuit/s 110, canopy discharge bar/s 112, and/or other components. The plant 103 can include roots 115, a canopy, a trunk, branches, stems, shoots, and/or other features. For example, plants 103 can be embodied as trees, flowers, bushes, crops, herbs, and/or any other plant that can receive high voltage treatment according to various embodiments of the present disclosure.

The roots 115 of the plant 103, the trunk of the plant 103, or other suitable portion of the plant 103 can function as a part of discharge circuit/s 110, of the high voltage plant treatment system 100. For example, at least a ground discharge point/s 117, can be inserted into the soil 102 proximate to the roots 115 of the plant 103 to provide a ground discharge point/s 117. In other implementations, a conductor discharge bar may be used to implement numbers of discharge circuit 110, limited to infinity number of discharge circuit/s 110, while the canopy discharge bar/s 112, moving inside the canopy and for example the ground discharge bar/s 122, move on the ground.

The DC voltage source 106 (e.g., a battery or AC/DC power supply) includes a positive terminal and a negative terminal. In one embodiment, the DC voltage source 106 can provide 12 volt (V) or higher, preferably direct current (DC) power. However, it should be appreciated that the voltage provided by the DC voltage source 106 can vary among embodiments. In embodiments where the negative ground discharge point/s 117 of the DC voltage source 106 is connected proximate to the roots 115 of the plant 103, canopy discharge point/s 114 are located throughout the canopy of the plant 103.

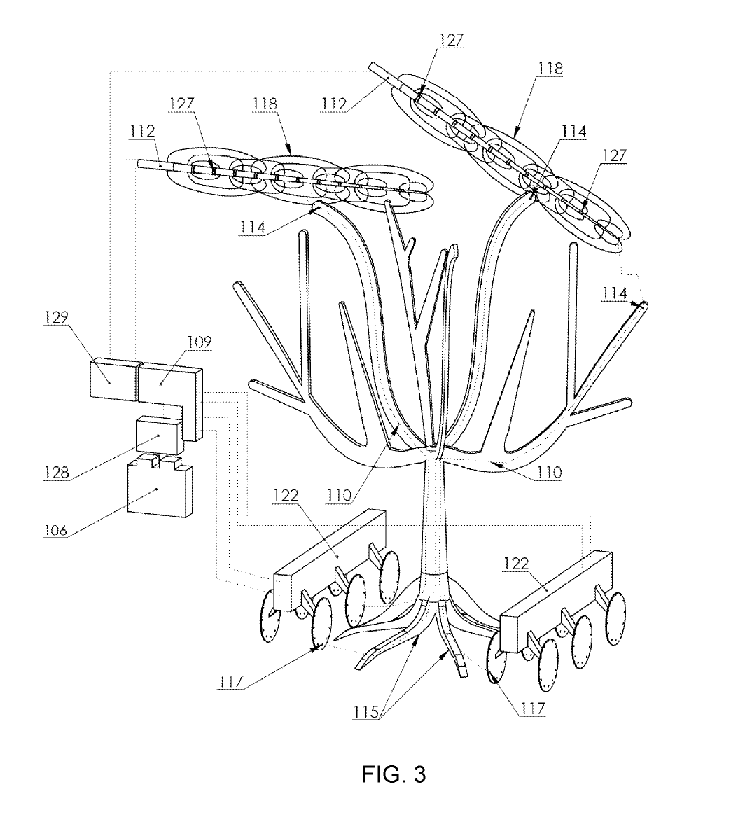

The positive terminal of the DC voltage source 106 can be connected to the distribution unit 109 and the high voltage pulse/s generator via a conductor such as, but not limited to, a wire. In one embodiment, the distribution unit 109 includes an ignition coil, a distributor, and other components, which will be further discussed with reference to FIG. 3. In some embodiments, the distribution unit 109 is configured to control the transmission of high voltage pulse/s to discharge point/s 127 located on the discharge bar/s 112.

When the plant treatment system 100 is initiated, a relatively low voltage current (e.g., 12V) can be provided from the DC voltage source 106 to the distribution unit 109 and high voltage generator system 129. The distribution unit 109 can be configured to periodically generate high voltage pulses. The distribution unit 109 and high voltage generator system 129 can also be configured to control the release of the relatively high voltage pulses to the discharge circuit/s 110. When the high voltage pulse/s reaches the discharge point/s 127 on the discharge bar/s 112, a spark of high voltage current can be discharged from the discharge point/s 127 to canopy discharge point/s 114 on the plant 103 throughout the discharge circuit/s 110.

For example, the spark includes electrons which jump from the discharge point/s 127 to the canopy discharge point/s 114 on the plant 103. The high voltage discharge pulse/s passed to the plant 103 can induce an excitation current through the surface of the plant 103 and the internal systems of the plant 103. The current running through the plant 103 can disrupt or shake the ion charge bonds in the plant 103, which can lead to the destruction of pathogens in the plant 103.

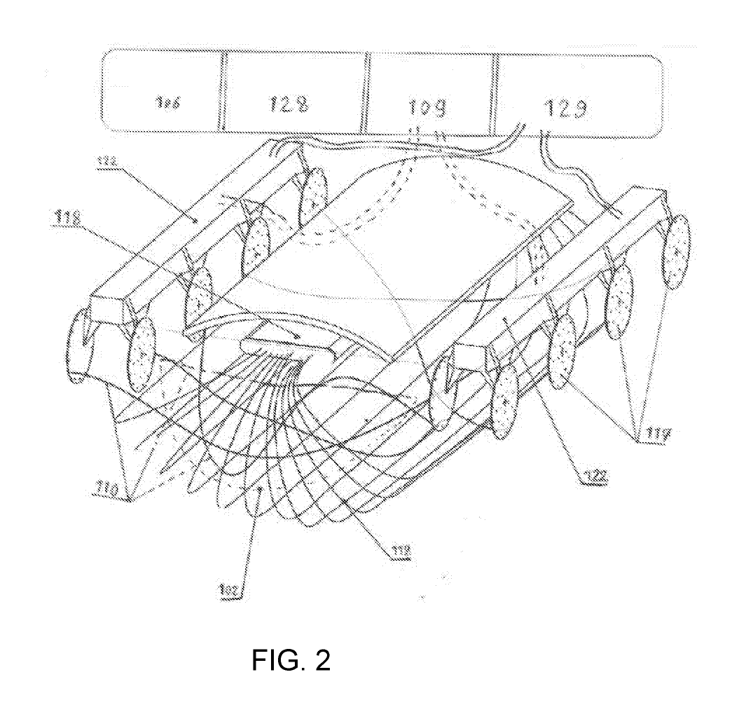

Referring now to FIG. 2, shown is a diagram illustrating an example of a voltage soil treatment system according to an embodiment of the present disclosure. The soil treatment system of FIG. 2 is structured similar to the embodiment of the plant treatment system. As illustrated in FIG. 2, the high voltage soil treatment system can comprise a ground connection or ground discharge bar/s 122. The soil 102 can be damp and conductive facilitating current flow through the soil particles.

In another embodiment, the ground discharge bar/s 122, or carrying the ground discharge point/s 117, can also stablish the discharge point/s at the soil under treatment 102. In yet another embodiment, the ground discharge bar can be coupled to any position on the soil 102 such that the ground discharge point/s 117, are located throughout the ground or other portions of the soil under treatment 102.

In the embodiment illustrated in FIG. 2, the distribution unit 109 and high voltage generator system 129 can further comprise an ignition coil or an electronic type high voltage generator, a distributor, and/or other components. In one embodiment, the distributor 109 can comprise a shaft, breaker point, a capacitor, and/or other components. A device configured to rotate the shaft can be coupled to the shaft.

For example, a 12 VDC electromotor can be used to rotate the shaft at a predefined speed such as, e.g., about 120 less or more, revolutions per minute (RPM). It should be appreciated that the voltage and/or revolutions per minute of the device rotating the shaft can vary among the embodiments. The shaft can comprise a cam that opens and closes the breaker point as the shaft rotates.

In one of the embodiments controller unit/s 128 is comprising but not limited to; possible switch relay/s, multiplexer/s, micro controller/s, programmable devices plus other electronic or mechanical components which aim to characteristics control and adjustment of the high voltage pulse/s like; voltage-amperage magnitude, duration, direction, frequency, and rhythm or timing the pulse/s, however, using of the said controller unit/s, is also for control and adjustment of the electromagnetic characteristics like; flux density, amplitude, duration, direction, frequency, and rhythm or timing of the pulse/s during the treatment.

In some of the embodiments, the release of the high voltage energy can trigger a spark from the discharge point/s 127. For example, the high voltage energy can discharge across the gap between the discharge point/s 127, and the canopy discharge point/s 114. As illustrated in FIG. 2, the ground discharge points 117, can be located on the soil 102 itself.

In this regard, the discharge is across a gap between the discharge point/s 127 and the relevant canopy discharge point/s 114. If a distance of the gap between the discharge point/s 127 and the canopy discharge point/s 114 is too big, then the spark of high voltage energy will not occur. In such a case, the next discharge of high voltage energy from the positive discharge point/s 127 can be at a relatively higher voltage than would have been present at that instant.

In some embodiments, the high voltage energy generated in the ignition coil 206 or other electronic circuit configured to generate the high voltage energy, which can reach 50 kV or much more In some embodiments, the current flowing across the gap and into the plant 103 can be in a range from about 5 mA to about 57 mA. Other ranges are also possible, and may be adjusted.

In some embodiments, the high voltage discharge between the discharge point/s 127 and the canopy discharge point/s 114 can last for a duration of about 1 ms or less to about 10 ms or more. However, the duration of the discharge will depend upon the timing of the electronic circuitry of the high voltage sparks and the controllers. The duration for voltage treatment can depend at least in part upon the timing of the pulsed current generated in the distribution unit 109. In some embodiments, the voltage treatment can be applied to the plant 103 for a pre-defined period of time of each day for a number of days, until a desired number of healthy new shoots and/or leaves have grown on the plant 103.

The discharge bar/s 112 can include a plurality of discharge point/s 127. It should be appreciated that the number of positive discharge point/s 127 and/or the number of discharge circuit/s 110 can vary among embodiments. In a handy or manual kind of the high voltage treatment device, a user can hold the discharge bar/s 112 by a handle, for example, and move the discharge bar/s 112 proximate to the portion/s of the plant 103 to be treated.

For example, if the user of the voltage plant treatment system determines that the distance of the gap between the positive discharge point/s 127 and the canopy discharge point/s 114 is too big and thus discharges (or sparks) are not occurring or the discharge voltages are too high, then by moving the discharge bar/s 112, closer to the plant 103 the gap distance the discharge take place.

FIG. 3 is illustrated two of an exemplary discharge bar/s 112 of the voltage plant treatment system. In particular, FIG. 3 shows the discharge bar/s 112 as described with respect to FIG. 1 with electromagnetic field 118. In the embodiment illustrated in FIG. 3, the discharge bar/s 112 further comprises; canopy discharge point/s 114, controller 128 magnetic field 118, ground discharge point/s 117, ground discharge bar/s 122, discharge circuit/s 110 and/or other components. In handy use device, a user can carry the discharge bar/s 112 safely by following all regulation, also, using the non-conductive handle. As such, the handle can be configured to protect the user from being electrocuted by the high voltage energy generated by the embodiments disclosed herein.

For instance, the handle of the discharge bar/s 112 can comprise electrical insulating material such as rubber, plastic, and/or other suitable material or combination of materials that prevents the user from being electrocuted when using the discharge bar/s 112. For safety all the standard and regulation should be considered. Cut-off switch/s while operation stopped or when the gap distance between discharge points is more than a safety gap will stop generating high voltage pulses.

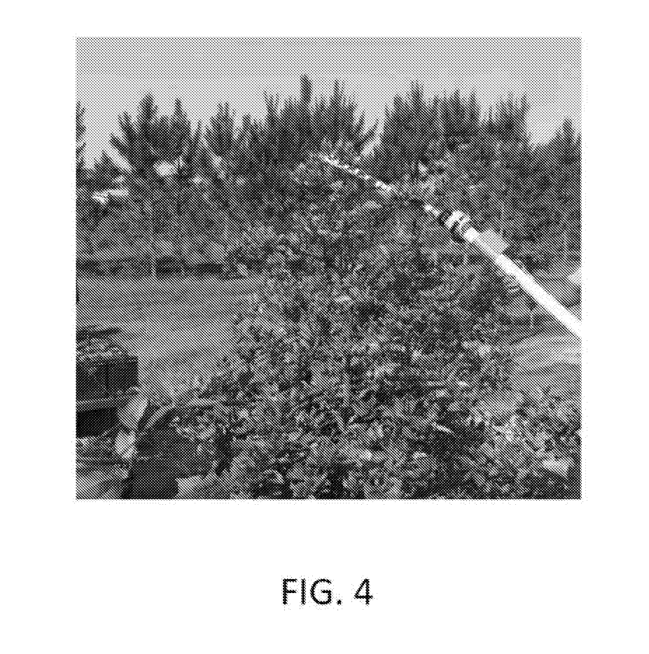

Similarly, FIG. 4 is a photo illustrating the use of the canopy discharge bar/s 112 of FIG. 3 in conjunction with an infected plant 103. In the examples of FIG. 4 the discharge bar/s 112 is secured in position to the handle. As illustrated in FIG. 4, the user of the voltage plant treatment system can place the discharge bar/s 112 proximate to the branches and/or the leaves of the plant 103. As described above, the discharge bar/s 112 will release high voltage energy into the plant 103 thereby inducing a pulsed current into the plant 103. The current can disrupt ion charge bonds in the plant 103, which can destroy pathogens in the plant 103.

FIG. 4 is an image showing a user employing the voltage plant treatment system of FIG. 1. As illustrated in FIG. 4, the user positions the discharge bails 112 by holding the handle. The discharge bar/s 112 can be moved inside the plant canopy using the handle as shown. As described above with reference to FIG. 3, the handle can comprise electrically insulating material that can prevent the user from being electrocuted while using the voltage plant treatment system.

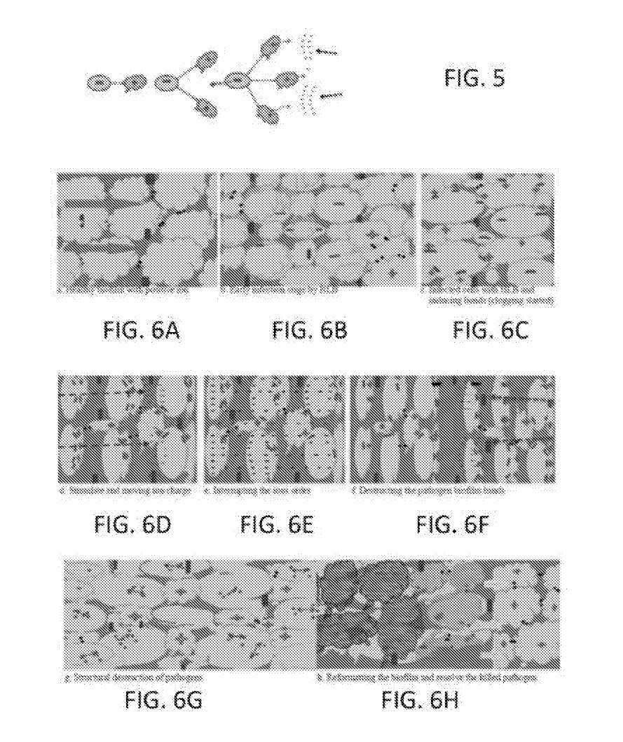

FIG. 5 is hypothesize of the behavior of plant when subjected to an electrical treatment. FIG. 5 as a graphical representation, illustrating an example of the movement of ion charges in a plant 103, treated by a high voltage plant treatment system of FIG. 4 according to various embodiments in the present disclosure. In particular, FIG. 5 depicts an example of how similar ion charges repel each other while opposite ion charges attract each other. In this way, subjecting ion charge bonds to a distinguished high voltage electrons flow which, may or may not be simultaneously under influence of an electromagnetic field 118, can result in a degradation, segregation and garbled of ion charge bonds for pathogens. When plant 103 (FIG. 1) is introduced into an electrical field, similar ion charges repel each other while dissimilar ion charges attract each other. In the embodiments disclosed herein, the plant 103 can act as a conductor and the DC voltage source 106 can be a DC voltage source 106 where the electrons move continuously or by any frequency and uniformity from a positive terminal to a negative terminal through the circuit and/or conductors of the voltage plant treatment system.

FIGS. 6A-6H are graphical representations illustrating an example of interactions between electrons, biofilms, and pathogens in a plant 103 (FIG. 1) treated by the voltage plant treatment system of FIG. 4 according to various embodiments of the present disclosure. FIG. 6A illustrates a healthy biofilm that can for example, comprise positive or cation ion charges. FIG. 6B illustrates the biofilm at an early stage after being infected by for example, HLB pathogens. As shown in FIG. 6B, HLB pathogens can comprise negative or anion ion charges. Traditionally, once a plant 103 has been infected with HLB, the plant 103 will decline a short time thereafter and eventually will die.

FIG. 6C illustrates an example of the HLB pathogens causing the formation of new and strong bonds which can result in the clogging of the phloem sieves gate. FIG. 6D illustrates an example of the movement of the ion charges after being infected with HLB.

FIGS. 6E-6H illustrate examples of conditions of the infected plant 103 after receiving the voltage treatment. First, conduction of the discharge current through the plant 103 can be improved by dampening the plant 103 with water, for example. In this way, the plant 103 functions as a conductor such that electrons flow from positive discharge point/s to jump on the plant 103, reopening the clogged vascular system or disrupting the cogged bonds in the vascular system, the plant 103. FIG. 6E illustrates that inducing a current in the plant 103 can cause changes in the formation of the ion charges net order of the plant vascular system. For example, inducing a high voltage pulsed current in which, may be applied under influence of electro-magnetic field 118, in the plant under treatment 103 can cause reopening the vascular system of the plant 103. Such treatment, pull the bonds by impact of storm of electrons to push against each other, thereby breaking ion bonds within and/or on the plant 103. The extent of disruption of the bonds in plant 103 can depend on the tolerance of different cells in the plant 103 and their corresponding bonds and/or connections, which can be optimized for other pest management and diseases control.

The pulsed current induced in the plant 103 can continuously reorder the ion charge/s bonds in the plant 103 because of the disrupted ion bonds and/or changing the active discharge points. In some embodiments, the effect of the electrons flowing in the plant 103 is to degrade the weaker bonds by breaking or disrupting them. This disruption of bonds can destroy pathogens, including HLB pathogens, in the plant 103 can be useful to rescue the plant back to life. As the discharge point/s 127 release the high voltage current to plant through discharge circuit/s 110, due to the high voltage pulses and the current, the pathogen-biofilm bonds bonds can diffuse into smaller parts.

After the plant 103 is subjected to the induced current, the pathogen-biofilm bonds that clogs the vascular in the infected plant 103 can be destroyed. FIG. 6F illustrates an example of the destruction of the pathogen-biofilm bands in response to the induced current under influence of electromagnetic field 118. As the discharge point/s 127 are interrupted due to the current flowing through the plant 103, the pathogen-biofilm can diffuse into smaller parts, as shown in FIG. 6G. The amount of diffusion and speed of diffusion of the pathogen-biofilm bonds depends on the pathogen-biofilm bond conditions and infection and also, depends on the level of voltage and current used. FIG. 6H illustrates an example of a reformation of the biofilm in the plant 103 that can resolve the killed pathogens after the plant 103 has received the magnetic-voltage treatment. As shown in FIG. 6H, after the plant 103 is no longer under the influence of the voltage plant treatment system, the cells can reformat the biofilm and resolve the destroyed HLB structures. In the same scenario the release high voltage current into soil particles 102 can control the soil nematodes.

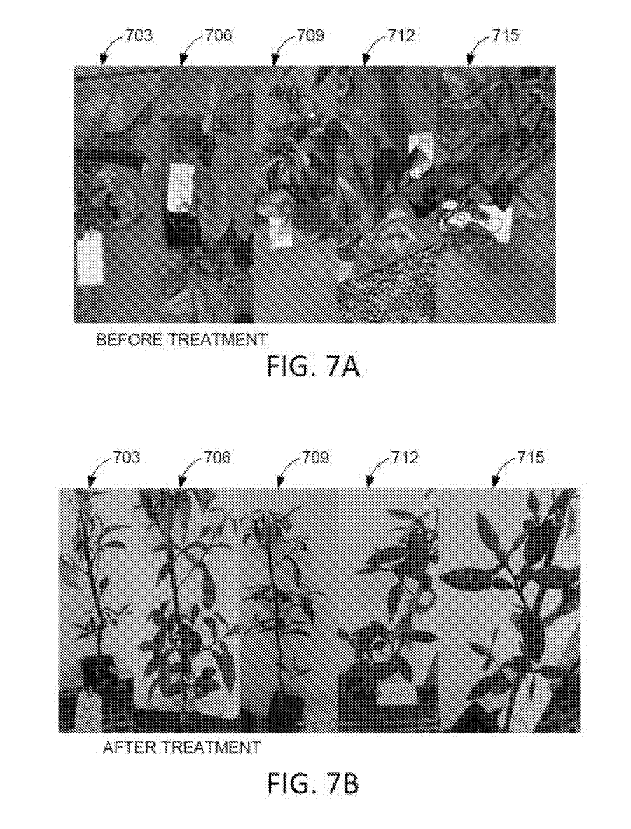

FIGS. 7A and 7B are images illustrating examples of infected seedlings treatment by the voltage plant treatment system of FIG. 4. In particular, the methods and devices described herein were tested on sample seedlings. FIG. 7A shows the seedlings 703-715 before voltage treatment and FIG. 7A shows the seedlings 703-715 after the voltage treatment. Results show that after voltage treatment, the seedlings grew new shoots throughout the body of the seedling and did not exhibit subsequent HLB symptoms. Results also show that the voltage plant treatment did not harm the infected plant during the treatment.

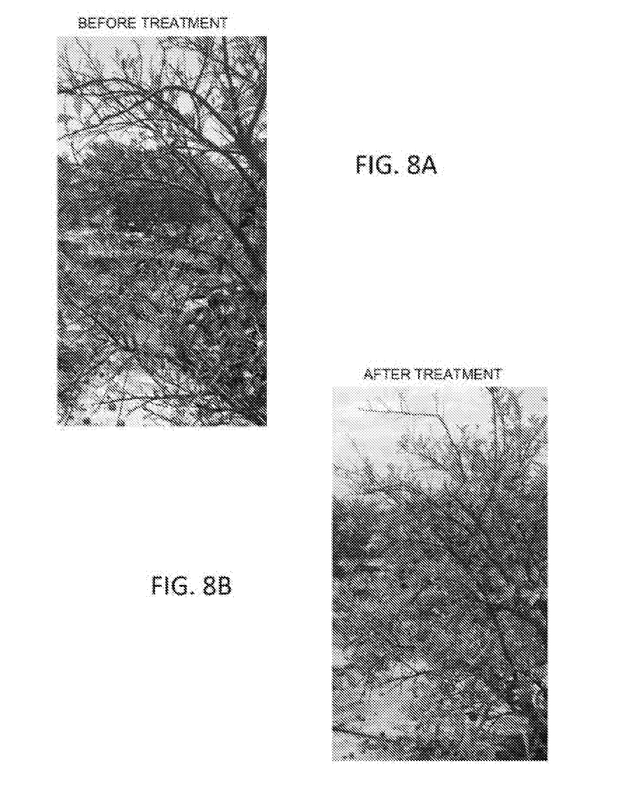

FIGS. 8A and 8B are images of an infected tree before and after treatment by the voltage plant treatment system of FIG. 4. FIG. 8A shows the tree before voltage treatment, and FIG. 8B shows the tree after receiving voltage treatment about 22 days later. Results show that after voltage treatment, the trees grew new shoots and leaves throughout the body of the tree and each of the new shoots and leaves showed no symptoms of HLB, even after one month of growth. Results also show that the voltage plant treatment did not harm the infected plant during the treatment.

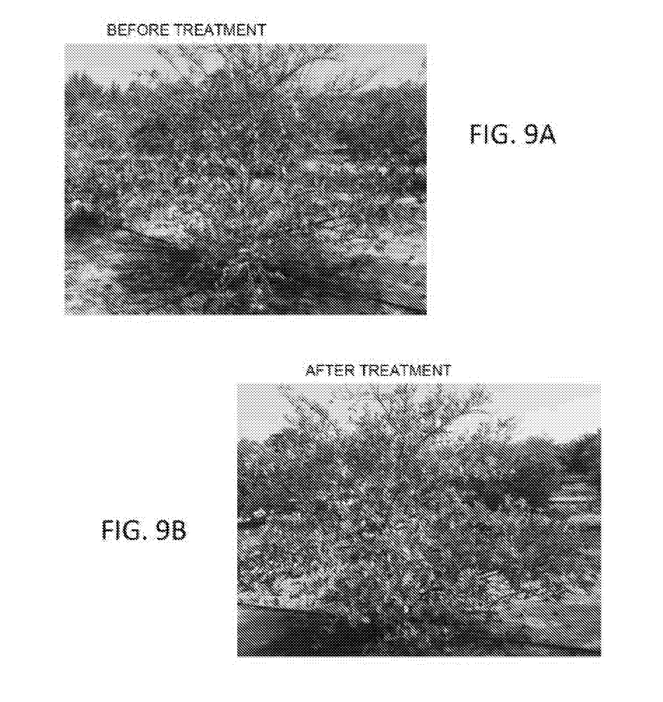

FIGS. 9A-9B are images of another infected tree before and after treatment by the voltage plant treatment system of FIG. 4. Specifically, FIG. 9A shows the tree before voltage treatment, and FIG. 9B shows the tree after receiving voltage treatment, later after 30 days. For example, the tree shown in FIGS. 9A and 9B received the high voltage treatment. As shown in the FIGS. 9A and 9B, treating the infected tree with the voltage treatment resulted in a tree with a higher number of shoots and leaves. The new shoots and leaves that grew after the treatment looked healthier than the leaves on the tree that were present before the treatment. Additionally, the voltage plant treatment did not harm the infected plant during treatment.

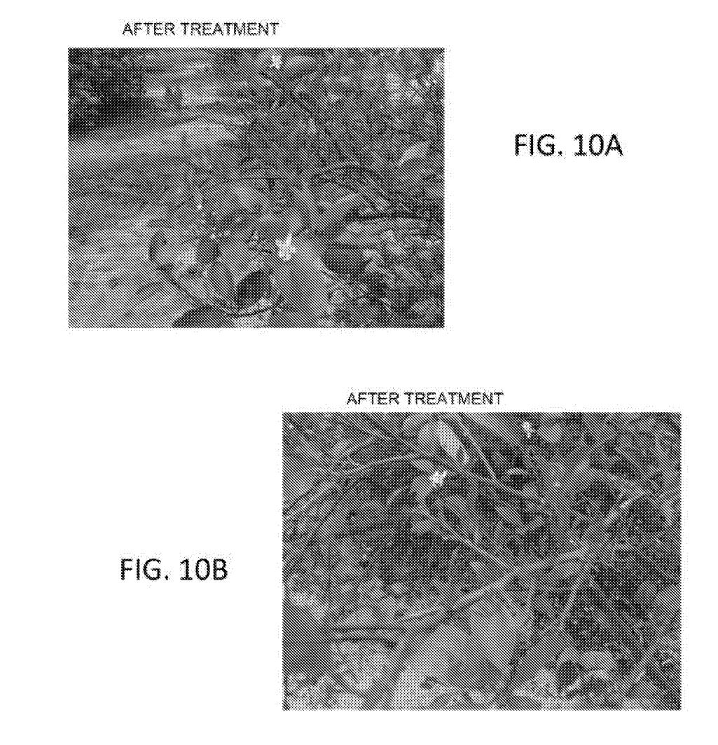

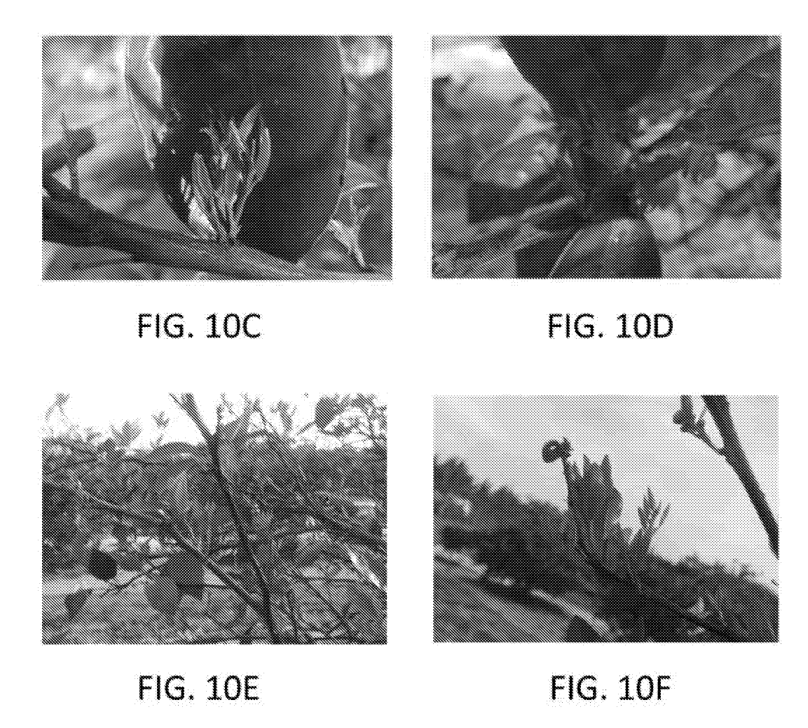

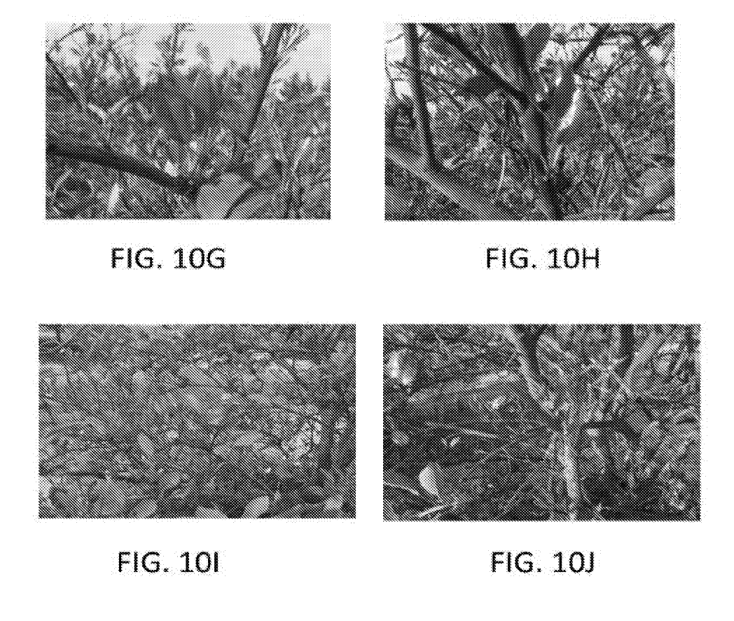

FIGS. 10A-10J are images showing new shoots of an infected plant after treatment by the voltage plant treatment system of FIG. 4. More specifically, FIGS. 10A-10J are zoomed in photographs of new shoots and/or leaves that grew on the tree or seedling after the voltage treatment. As illustrated by FIGS. 10A-10J, the new shoots and/or leaves appeared healthy and visually did not exhibit any subsequent symptoms of HLB infection. As such, the voltage plant treatment did not harm plants during treatment.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

It should be noted this treatment and working with electricity may cause damage and serious injury or death. The user should be aware of the risk of operation on his/her own, and should follow all necessary rolls and protection which if ignored, could result in death or serious personal injury caused by incorrect operation of the equipments. Invertor specifically disclaims any implied warranty of non-infringement or merchantability or fitness for a particular purpose and will in no event be liable for any indirect, consequential, incidental, special or aggravated or other similar or like damages or losses, including any loss of profits, arising from any defect, error or failure to perform, even if it has been advised of the possibility of such damages or losses.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

### SUMMARY

Several investigation have shown yield increases from plants which were subjected to an electrical treatment, although, there is no background related to use of high voltage for pest management. The high voltage electricity treatment can be used to reduce the effects of pest infestation in plant and soil. For example, Huanglongbing (HLB) infects citrus trees and have resulted economic loss to farmers. Available industry treatments consist of chemicals and steams that do not effectively control the diseases nor reach to the tree's or plant roots. In the same scenario; borer insects may feed in the burrow beneath the bark with no control. The trees infested by borer insects in severe infestations can result in the decline and death. Also, the most effective nematicide (Temik G15) is no longer available. This device functions by inducing a high voltage, low amperage current through an infected plant or soil particles. The high voltage treatment can be used in combination with other plant diseases to reduce the usage of chemicals. The treatment can also, increase the growth, break the dormancy and cause advance blooming. The high voltage treatment through number/numbers of discharge circuits, can shake, break, or interrupt the clogged vascular xylem or phloem by the pathogen-biofilm clogging bonds, which results material movement and stirabout in vascular system. These pathogens by formation of strong bonds in extensive necrosis cause clogging of sieves in the phloem of the plant. Subsequently, combat with the weaker and garbled bonds is much easier and the other treatments become more effective.

### Advantages

Environmentally friendly, eliminating need for harmful chemicals, Machines would be easily designed and portable, lowering costs and increasing ease of treatments, Voltage penetrates to the tree's roots, killing bacteria and nematodes, Stimulates plants or trees and improves health, Potentially increasing season for tree growth . . .

### REFERENCE

Apparatus for electroculture patented, by; Vernon F. J Marcoux et al. 1971, U.S. Pat. No. 3,559,33

Apparatus for generating and applying electrostatic energy patented, by; Kenneth E. Golden et al. 1934, U.S. Pat. No. 1,952,588

Apparatus for electrically charging liquid droplets for use in the stimulation of plant growth and/or the control of insects, by; Basil Earle Wainwright et, al. 1989, U.S. Pat. No. 5,052,628

Method of stimulating plant growth, by; Reiner Schultheiss et, al. 2009, U.S. Pat. No. 7,600,343 B2

Method for the treatment of plants using electro-magnetic fields, by; Peter Gleim, Triesen, 2011 US patent No.: US 2011/0283607 A1

Plant growth promotion device and method of using the device, by; Tsugumitsu Matsui 2014, US patent No.: CA 2829640 A1

Therefore, at least the following is claimed:

1. A plant, tree or/and soil treatment system, comprising but not limited to:
At least one voltage source/s, distributer unit/s, discharge point/s, controller/s, high voltage low amperage producer unit/s and electro-magnetic creator unit/s; in which, the electro-invasion of high voltage pulse/s or discharge of electron storm takes-place from discharge point/s; for example “A” to the discharge point/s; for example “B”, via plant, tree or/and soil particles as a part of a discharge circuit/s.

2. The discharge circuit/s according to claim 1, wherein said “discharge circuit/s” are pathways of the electrons flow, from one discharge point/s to another discharge point/s via plant, tree or soil particles as a part of circuit/s, in which, the invasive electrons or pulse/s spurted into said subjects under treatment (plant, tree or soil particles), optionally, with or without the existing of influence of the magnetic field simultaneously in treatment region.

3. The according to claim 2, wherein said “circuit/s pathway” are the pathways that, the said electrons, flow through the plant, tree or/and soil, as a part of discharge circuit/s from one point to another point/s with different position in the subject which, can be any type of circuit/s, in the term of length, figure, distortedness and form with number of one limited up to infinity discharge circuit/s through the plant, tree or/and soil particles.

4. The discharge point/s according to claim 1, wherein said “discharge of electrons” is comprising; at least one positive discharge point, for example “A”, receives high voltage pulse/s generated by the high voltage low amperage producer unit/s, and discharges the said pulse/s into plant, tree or soil, while, at least one negative discharge point, for example “B” , receives the said pulse/s traveled via plant, tree, or soil particles, whereas, the said discharge point/s can frequently convert to each other and change the direction of electrons flow.

5. The voltage source according to claim 1, wherein said “voltage source/s and distributer unit/s” is comprising; preferably, at least a “DC” voltage source/s provide the proper current or voltage to distributer unit/s to be distributed to a high voltage low amperage producer unit/s, to generate the high voltage pulse/s with respect to magnitude of the voltage-amperage of the pulses and also, with respect to kind of terminal charges and distribute the said pulse/s to different discharge point/s.

6. The electromagnetic according to claim 2, wherein said “with or without the existing of influence of the magnetic field” is comprising; an electro-magnetic field creator unit/s, which receiving the power from the voltage source/s to generate an electromagnetic field influencing the said discharge circuit/s which, the said electromagnetic field can stablish around the discharge point/s on/along the discharge bar/s also, the said electromagnetic field can be generated and stablish an electromagnetic field all around the plant, tree or/and soil region under the treatment.

7. The controller according to claim 1, wherein said “controller unit/s” is comprising but not limited to; possible switch relay/s, multiplexer/s, micro controller/s, programmable devices plus other electronic or mechanical components which, aim to control and adjustment the characteristics of the high voltage pulse/s like; voltage-amperage magnitude, duration, direction, frequency, and rhythm or timing the pulse/s, however, using of the said controller unit/s, is also, for control and adjustment of the electromagnetic characteristics like; flux density, amplitude, duration, direction, frequency, and rhythm or timing of the pulse/s during the treatment.

8. The said high voltage low amperage treatment according to above claims, using the voltage about 12V or less to 120 KV or more with amperage around 0.1 mA or less to 57 mA or more.

9. The method/s of high voltage treatment for plant, tree or/and soil according to all of the above claims, is as a method to control or/and reduce the impact of infestation of some pest/s or diseases in plant, tree or/and soil.

10. The method/s of high voltage treatment according to claim 8, can be used in combination of other plant diseases to reduce the usage of chemicals.

11. The said high voltage treatment according to above claims, can increase the growth, break the dormancy and cause advance blooming.

12. The said high voltage treatment through number/numbers of discharge circuits limited to infinity, is to shake, break, or interrupt the clogged vascular xylem or phloem by the pathogen-biofilm clogging bonds, which the shaking and disturbing those bonds results material movement and stirabout in vascular system, subsequently combat with the weaker and garbled bonds is much easier and the other treatments become more effective.
